(19) United States
(12) Patent Application Publication
(10) Pub. No.: US 2026/0340874 A1
(43) Pub. Date: Oct. 29, 2026

(54) MULTI-CAMERA VALIDATION USING KEYPOINTS ON A RIGID STRUCTURE

(71) Applicant: Walmart Apollo, LLC, Bentonville, AR (US)

(72) Inventors: Abhinav Pachauri, Bangalore (IN); Raghava Balusu, Achanta (IN); Wei Wang, Dallas, TX (US); Feiyun Zhu, Plano, TX (US); Huanyu Zang, Frisco, TX (US); Han Zhang, Allen, TX (US); Rohitashwa Chakraborty, Dallas, TX (US); Xin Ma, Arlington, TX (US); Avinash M. Jade, Bangalore (IN); Zhaoliang Duan, Frisco, TX (US); William Craig Robinson, Centerton, AR (US); Nilesh Pandey, Santa Clara, CA (US)

(21) Appl. No.: 19/651,919

(22) Filed: Apr. 20, 2026

Related U.S. Application Data
(60) Provisional application No. 63/794,551, filed on Apr. 25, 2025.

(51) Int. Cl. G06T 7/80; G06T 7/13; G06T 7/73; G06V 10/776

(52) U.S. Cl. CPC G06T 7/80; G06T 7/13; G06T 7/73; G06V 10/776; G06T 2207/30244; G06V 2201/07

(57) ABSTRACT

Examples provide a system and method for multi-camera validation and guided calibration using keypoints. Multi-view images of a cart or other object of interest are generated by a plurality of image capture devices mounted to a rigid support structure. A set of keypoints associated with the support structure are detected. The keypoints include fixed regions or points on the structure, such as corners and/or vertical support members of the structure. A homography is calculated for the multi-view images using the keypoints. The system utilizes computer vision (CV) analysis of the images to determine whether the object of interest is within the field of view of every image capture device. The system checks camera parameters using the images and the calculated homography. The system provides a pass status for each image capture device or guided instructions to assist a user in re-calibrating any image capture device failing verification.

### BACKGROUND

Cameras can be used for computer vision (CV) detection and recognition of items, such as shopping carts and products inside the shopping carts. Carts and other objects of interest inside the carts can be detected as the carts exit a store. Installing and monitoring multiple cameras at exit can be challenging. Camera installation and calibration is currently a slow, imprecise, and manual process.

### BRIEF DESCRIPTION OF THE DRAWINGS

FIG. 1 is an exemplary block diagram illustrating a system for validating and guiding re-calibration of multiple cameras using keypoints on a rigid support structure.

FIG. 2 is an exemplary block diagram illustrating a rigid support structure including a plurality of image capture devices.

FIG. 3 is an exemplary block diagram illustrating an archway truss device for supporting a plurality of image capture devices generating multi-view image data for a plurality of items.

FIG. 4 is an exemplary block diagram illustrating an archway truss supporting two or more image capture devices.

FIG. 5 is an exemplary block diagram illustrating a multi-lane archway truss device supporting multiple image capture devices.

FIG. 6 is an exemplary block diagram illustrating a camera manager for validating and guiding re-calibration of multiple image capture devices on a rigid support structure.

FIG. 7 is an exemplary diagram illustrating a field of view (FOV) of each camera in a plurality of cameras mounted on an archway truss device.

FIG. 8 is an exemplary top view image showing an object of interest within a FOV of a camera mounted to a horizontal top member of an archway truss device including bounding boxes enclosing an active cart.

FIG. 9 is an exemplary side view image showing an object of interest within a FOV of a camera mounted to a vertical support member of an archway truss device including bounding boxes enclosing an active cart.

FIG. 10 is an exemplary top view image including reference regions on an archway truss device for detecting objects of interest

FIG. 11 is an exemplary side view image including reference regions on an archway truss device.

FIG. 12 is an exemplary top view image showing reference regions on an archway truss device enclosed by bounding boxes with an instruction for re-calibrating the image capture device.

FIG. 13 is an exemplary top view image showing reference regions on an archway truss device enclosed by bounding boxes with a pass status for the image capture device validation.

FIG. 14 is an exemplary flow chart illustrating operation of the computing device to validate a plurality of image capture devices mounted to a rigid support structure using a plurality of keypoints.

FIG. 15 is an exemplary flow chart illustrating operation of the computing device to validate each camera in a plurality of cameras mounted on a rigid support structure.

FIG. 16 is an exemplary flow chart illustrating operation of the computing device to calculate a homography estimation for a camera.

FIG. 17 is an exemplary flow chart illustrating operation of the computing device to generate validation feedback for cameras on an archway truss.

FIG. 18 is an exemplary diagram illustrating a user interface including validation feedback for a camera.

FIG. 19 is an exemplary table illustrating validation results for a set of three cameras.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Each exit lane in an archway truss device has multiple cameras with redefined IPs for cameras in each exit lane. Camera IPs need to be perfectly assigned and aligned. Each camera needs to be perfectly mounted at the standard predefined position in terms of height, width, and depth inside an archway truss through which customers pushing shopping carts exit such that the view from each camera is standard across stores. Each camera view should be standard such that it covers the whole cart. A uniform standard view should always be maintained even after installation. Camera direction should be standard across stores. For example, one of the standards for a top camera can include a requirement for the camera to be positioned such that a cart in the FOV moves from right to left through the FOV. The standard direction of cameras needs to be maintained and monitored. If one or more of the cameras are incorrectly installed, positioned, misaligned, or incorrectly calibrated, it can result in blurry, low-resolution images, blocked camera views, and/or camera views that are not leveled, rendering CV model results incomplete, inaccurate, and/or unreliable.

A homography matrix can be used to perform perspective transformation from one camera view to another, which is widely required for multi-camera systems to understand the whole situation or scene. A homography matrix can be used to associate the same cart captured across three different camera views, even where multiple carts are visible within the images. A typical solution is to place a checkerboard on the plane for homography calculation. For example, if the system needs to know the transformation of the ground plane across three different views, a checkerboard pattern can be laid on the ground for calibration of the cameras. However, for real store operations, it is not practical to maintain a checkerboard on the ground in high traffic areas where the checkerboard pattern is subject to wear and tear and may cause safety concerns.

Moreover, installing all cameras perfectly while following all standards manually is challenging, time-consuming, and unscalable where there are large numbers of cameras installed in potentially hundreds or even thousands of stores. Thus, there is a need for an automated guidance tool for installation and validation of multiple cameras within high traffic areas of retail facilities and other locations subject to foot traffic.

Referring to the figures, examples of the disclosure enable automated validation of camera parameters and automated re-calibration guidance using multi-view image data and keypoints on a rigid support structure. In some examples, the system enables automated validation of camera parameters to determine if a camera is correctly installed or in need of adjustment, maintenance, or repair.

Aspects of the disclosure further enable a software tool for analyzing multi-view images from multiple cameras on an archway truss device with pre-defined keypoints on the archway truss device. The system provides a pass status for cameras which are operating within pre-defined parameters. It can provide guided instructions prompting a user to re-calibrate or otherwise adjust cameras which are not operating as expected. This enables more efficient and accurate installation and maintenance of cameras.

The computing device operates in an unconventional manner by providing real-time validation of image capture device operation and validation feedback associated with the validation results to guide users in correcting misalignments, incorrect internet protocol (IP) number assignment, device position, or other camera parameters which may be out-of-range of acceptable threshold parameter value ranges. This enables users to install, calibrate, and maintain multiple cameras associated with a rigid support structure quickly, efficiently, and accurately. In this manner, the computing device is used in an unconventional way, and allows accurate camera installation, calibration, and maintenance with greater accuracy and a reduced error rate, thereby improving the functioning of the cameras mounted on the archway truss device as well as improving the functioning of the underlying computing device.

Other embodiments provide validation feedback, including a pass status or guided instructions for correcting issues associated with one or more cameras, via a user interface. This further enables improved user efficiency via UI interaction and increased user interaction performance via the UI.

In other embodiments, the system provides dynamic camera maintenance instructions for ensuring an object of interest is within the FOV of every camera associated with an exit lane archway truss device. This enables faster installation and maintenance of cameras while ensuring uniform image quality from all cameras for a reduced error rate associated with computer vision (CV) machine learning (ML) model results, as well as reduced time expended servicing cameras mounted to the archway truss device.

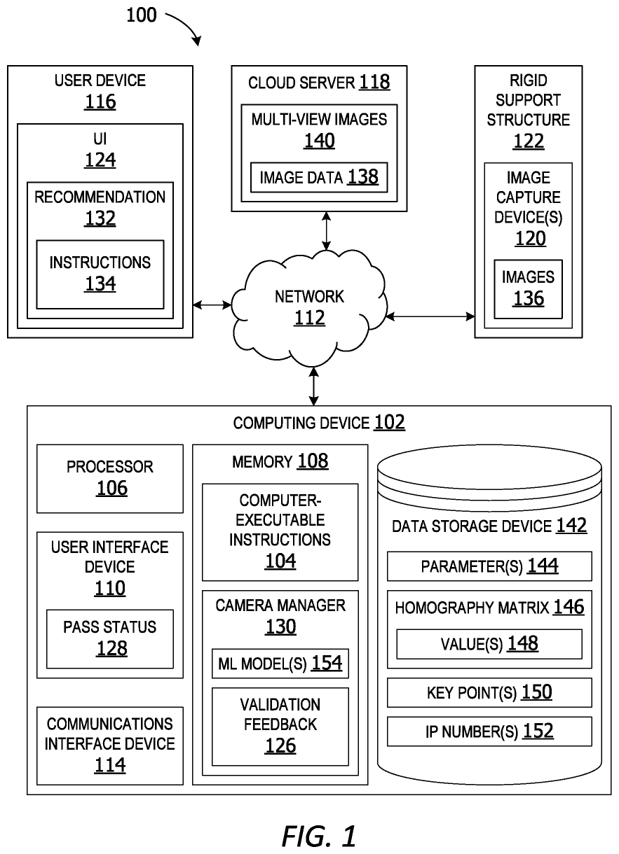

Referring again to FIG. 1, an exemplary block diagram illustrates a system 100 for validating and guiding re-calibration of multiple cameras using keypoints on a rigid support structure. In the example of FIG. 1, the computing device 102 represents any device executing computer-executable instructions 104 (e.g., as application programs, operating system functionality, or both) to implement the operations and functionality associated with the computing device 102. The computing device 102, in some examples, includes a mobile computing device or any other portable device. A mobile computing device includes, for example, but without limitation, a mobile telephone, laptop, tablet, computing pad, netbook, gaming device, and/or portable media player.

The phrase “and/or” as used in the specification and in the claims should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

The indefinite articles “a” and “an,” as used in the specification and in the claims, unless clearly indicated to the contrary, should be understood to mean “at least one.” As used in the specification and in the claims, “or” should be understood to have the same meaning as “and/or” as defined above. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law. The use of “including,” “comprising,” “having,” “containing,” “involving,” and variations thereof, is meant to encompass the items listed thereafter and additional items.

The computing device 102 can also include less-portable devices, such as servers, desktop personal computers, kiosks, or tabletop devices. Additionally, the computing device 102 can represent a group of processing units or other computing devices.

In some examples, the computing device 102 has at least one processor 106 and a memory 108. As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

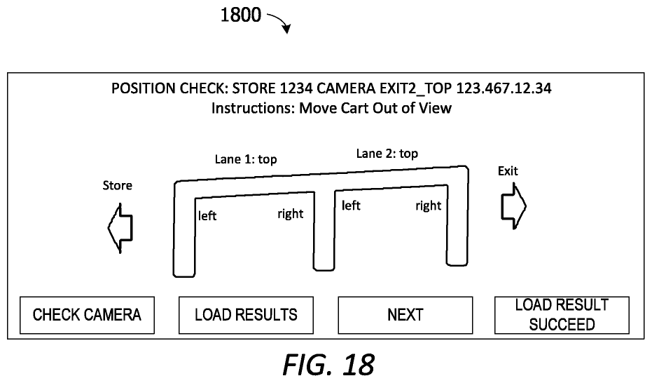

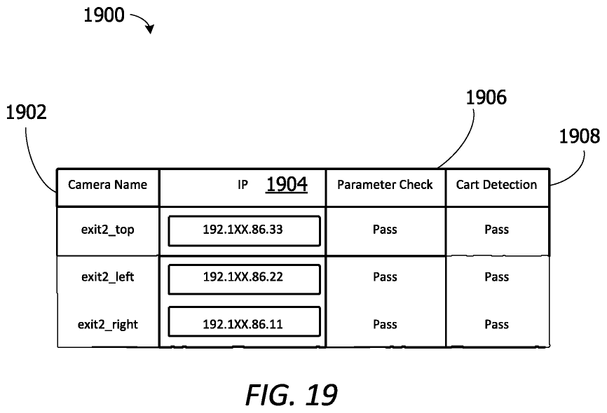

The processor 106 includes any quantity of processing units and is programmed to execute the computer-executable instructions 104. The computer-executable instructions 104 are performed by the processor 106, performed by multiple processors within the computing device 102, or performed by a processor external to the computing device 102. In some examples, the processor 106 is programmed to execute instructions such as those illustrated in the figures (e.g., FIG. 18, FIG. 19, FIG. 20, and FIG. 21).

The computing device 102 further has one or more computer-readable media, such as the memory 108. The memory 108 includes any quantity of media associated with or accessible by the computing device 102. The memory 108, in these examples, is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services, such as web services accessible via a network 112. In an example, the applications represent downloaded client-side applications that correspond to server-side services executing in a cloud.

The computing device 102, in other examples, includes a user interface device 110. The user interface device 110 can include a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. The term “BLUETOOTH®” as used herein refers, in some examples, to a wireless technology standard for exchanging data over short distances using short-wavelength radio transmission. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN. The term “Wi-Fi” as used herein refers, in some examples, to a wireless local area network using high-frequency radio signals for the transmission of data.

In some examples, the system 100 optionally includes a communications interface device 114. The communications interface device 114 includes a network interface card and/or computer-executable instructions (e.g., a driver) for operating the network interface card. Communication between the computing device 102 and other devices, such as, but not limited to, a user device 116, cloud server 118, and/or image capture device(s) 120 mounted to a rigid support structure 122, can occur using any protocol or mechanism over any wired or wireless connection. In some examples, the communications interface device 114 is operable with short-range communication technologies, such as using near-field communication (NFC) tags. The term “NFC” as used herein refers, in some examples, to a short-range high-frequency wireless communication technology for the exchange of data over short distances.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 124.

The UI 124 is a user interface device, such as, but not limited to, the user interface device 110. The UI 124 receives data from a user, such as, but not limited to, a request for the camera manager 130 to perform a validation check on one or more image capture device(s) 120. The UI 124 presents data to the user, such as, but not limited to, validation feedback 126 generated by the camera manager 130. The validation feedback 126 includes a pass status 128 and/or a recommendation 132. The pass status 128 indicates that an image capture device has been validated by the camera manager 130. The recommendation 132, in some embodiments, includes one or more instructions 134 guiding a user to re-calibrate or otherwise adjust the image capture device that has failed to receive a pass status 128. The validation feedback 126 is presented to the user via a UI, such as, but not limited to, the user interface device 110 and/or the UI 124 on the user device 116.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The one or more image capture device(s) 120 include devices for generating images 136 of an object of interest, such as, but not limited to, a shopping cart and/or contents of the shopping cart moving within a field of view (FOV) of the image capture device(s) 120. An image capture device is any type of device for generating one or more images, such as, but not limited to, a digital camera, an infrared camera, or any other type of image capture device. The images 136 can include color images or black-and-white images.

In these embodiments, the image(s) 136 and/or the multi-view images 140 do not include images of users or other individuals within the retail facility. Any images having human users or other objects which are not of interest inadvertently included within the images are removed from the image(s) by cropping the images such that only objects of interest remain in the cropped images. Images of users or objects which are not of interest are deleted or otherwise discarded. The cropped images containing only the objects of interest, such as shopping carts or cart contents, are then analyzed to identify and label the objects of interest within the cropped images. The objects of interest are optionally labeled by placing the objects inside one or more bounding boxes. The bounding boxes can be generated in one or more colors, such as red bounding boxes, green bounding boxes, or any other color.

In this non-limiting example, the image capture device(s) 120 include three cameras mounted to a portion of the rigid support structure defining a single lane of travel which is wide enough to permit a shopping cart to pass through. The shopping cart can include a hand-held basket, a shopping cart on wheels which is manually pushed by a user, a motorized shopping cart which enables a user to ride on the cart, or any other type of container for transporting one or more items in a retail environment. A cart can also be referred to as a basket.

In other examples, the image capture device(s) 120 include six cameras associated with two lanes of travel or nine cameras associated with three lanes of travel. However, the embodiments are not limited to three, six, or nine image capture devices. In other embodiments, the image capture device(s) 120 include one or more cameras or other type of image capture device attached to the rigid support structure. The image capture device(s) 120 can be removably attached to the rigid support structure or integrated into the support structure such that the image capture device(s) 120 are not removable. In this example, the image capture device(s) 120 are removably mounted to a frame of the rigid support structure.

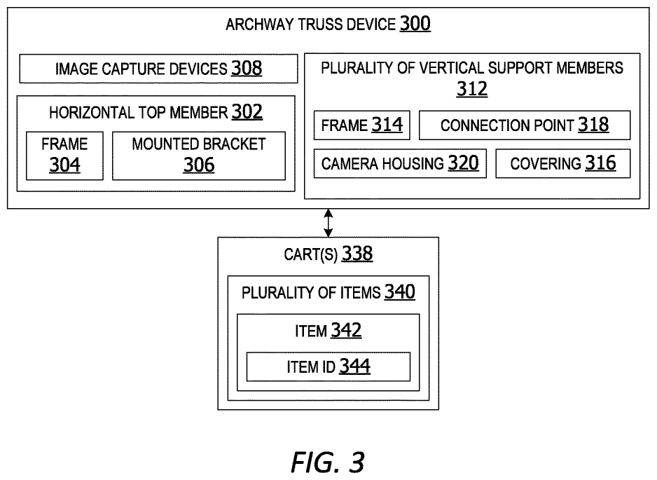

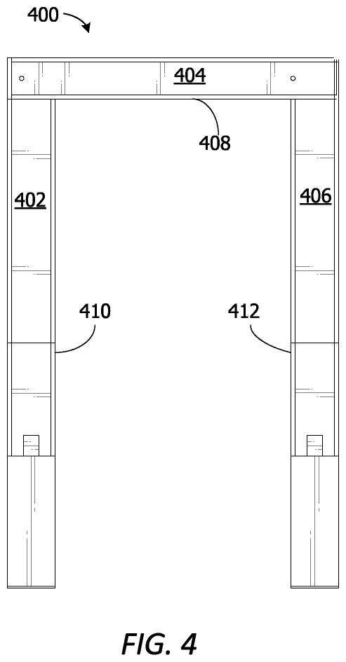

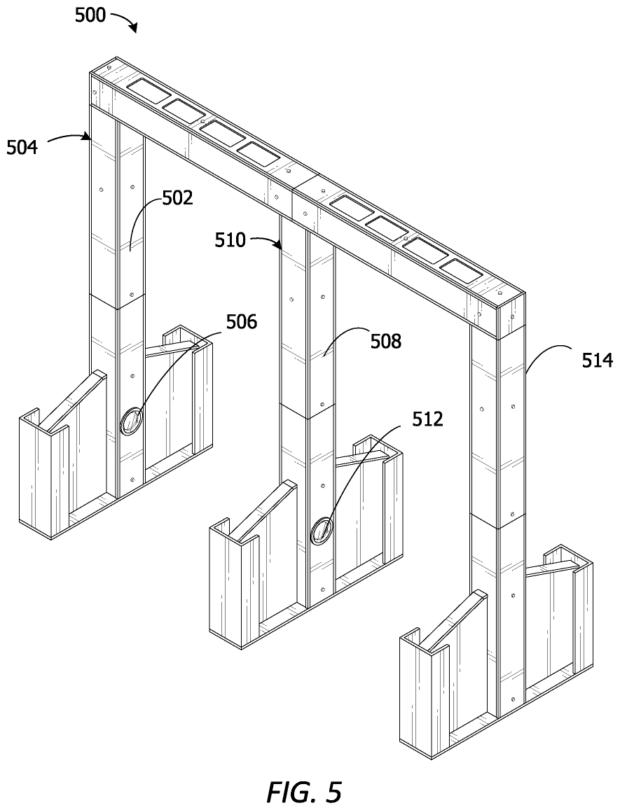

The rigid support structure 122 is a structure for supporting the image capture device(s) 120. The rigid support structure is any type of device for supporting the image capture device(s) 120. In this non-limiting example, the rigid support structure 122 is an archway truss device having one or more arch-shaped frames for defining one or more exit lanes through which shopping carts can pass as a user moves toward an exit of a retail facility, as shown in FIG. 3, FIG. 4, and/or FIG. 5. The image capture device(s) 120 are mounted to the frame and directed towards an interior space between the vertical support members of the rigid structure such that carts passing through the rigid support structure pass within the FOV of each image capture device mounted to a portion of the rigid support structure associated with a single exit lane.

In some embodiments, image data 138 associated with multi-view images 140 generated by multiple image capture devices mounted to the rigid support structure 122 is stored on a data storage device 142 and/or a cloud storage, such as a storage associated with the cloud server 118. Multi-view images 140 include images generated by two or more different image capture devices having two or more different FOVs.

In this example, the multi-view images 140 include images generated by an image capture device mounted to a horizontal top member of the rigid support structure having a bird's-eye-view of carts passing through the rigid support structure exit lane and images generated by one or more image capture devices mounted to one or more vertical support members on the rigid support structure. The top image capture device has a top view of the cart and the bottom image capture device(s) have a side view of the same cart passing through the exit lane.

The system 100 can optionally include the data storage device 142 for storing data, such as, but not limited to, one or more camera parameter(s) 144, a calculated homography matrix 146, one or more reference keypoint(s) 150 on the rigid support structure 122, internet protocol (IP) number(s) 152 assigned to the rigid support structure 122. The parameter(s) 144 include one or more image parameters associated with one or more of the image capture device(s) 120. The parameter(s) 144 are parameters associated with calibration of each image capture device, such as, but not limited to, the position of each image capture device on the support structure, focus, angle of the image capture device, or other parameters associated with the image capture device(s).

The homography matrix 146 includes one or more value(s) 148 for describing a relationship between two images of the same planar surface from two or more different viewpoints. In CV, the homography matrix is used to map points from one image to another image from a different perspective of a planar surface.

The keypoint(s) 150 include one or more static reference points on the rigid support structure 122. A keypoint, in some embodiments, includes a corner on a bottom portion of a vertical support structure on the rigid support structure. A keypoint, in other embodiments, includes a region or portion of the vertical support structure and/or a base member of the vertical support of the rigid support structure.

The data storage device 142 can include one or more different types of data storage devices, such as, for example, one or more rotating disk drives, one or more solid state drives (SSDs), and/or any other type of data storage device. The data storage device 142 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 142 includes a database.

The data storage device 142 in this example is included within the computing device 102, attached to the computing device, plugged into the computing device, or otherwise associated with the computing device 102. In other examples, the data storage device 142 includes a remote data storage accessed by the computing device via the network 112, such as a remote data storage device, a data storage in a remote data center, or a cloud storage.

The memory 108 in some examples stores one or more computer-executable components, such as, but not limited to, the camera manager 130. The camera manager component, when executed by the processor 106 of the computing device 102, obtains a plurality of multi-view images 140 of a cart from the image capture device(s) 120 mounted to the rigid support structure 122. The camera manager 130 utilizes one or more ML model(s) 154 to detect one or more of the keypoint(s) 150 on the rigid support structure 122 which are visible in one or more of the images using computer vision. In other words, the system utilizes a trained CV ML model in the one or more ML model(s) 154 to identify the keypoint(s) in the images of an object of interest captured by two or more different cameras having two or more different viewpoints of the same object of interest. The camera manager 130 calculates the homography matrix 146 associated with the plurality of multi-view images using the set of keypoint(s) 150. The camera manager determines whether the object of interest, such as a cart or checkerboard, appears within the FOV of each image capture device using the keypoint(s) and the calculated homography matrix. The system also checks one or more other parameter(s) 144 associated with the image capture device(s) 120 using the image data 138 and the keypoint(s) detected in each image. The camera manager 130 generates the validation feedback 126.

In some examples, the validation feedback can include an approval of each image capture device. Approval can be provided in the form of a pass status 128 or other feedback indicating the image capture device parameter(s) 144 are correct and/or no adjustments to the device are necessary. The validation feedback can also include a recommendation including instructions for re-calibrating an image capture device in the plurality of image capture devices having a FOV that fails to include substantially all of the object of interest within the device's FOV and/or one or more parameter(s) which fails to fall within an acceptable threshold range of values for the image capture device. The validation feedback 126 is presented to a user via a UI.

In some embodiments, the validation feedback 126 is interactive such that the user is prompted to perform a task or complete an action. The user indicates completion of the task or performance of the action via the UI. Once completed, the user is optionally prompted to perform a next action or complete a next task. The tasks or actions can include actions associated with re-calibrating a camera or otherwise adjusting one or more of the settings on the camera or other image capture device. For example, the user can be prompted to adjust an angle of a camera, clean the lens, adjust the lighting, or other task associated with repair, maintenance, installation, or calibration of one or more of the image capture device(s) 120.

In other embodiments, the system prompts the user to indicate whether the user is ready for the system to perform the validation of the image capture device again after the re-calibration or other adjustment is made. The system, in these examples, prompts a user to perform an action. Once complete, the system again attempts to validate the image capture device. If validation fails, the user is prompted by the system to perform another adjustment or re-calibration task on the given image capture device. Once the task is completed, validation is attempted again. Once validation is successful, the validation feedback is generated and output to the user via the UI. The user is optionally then prompted to trigger validation of the next image capture device.

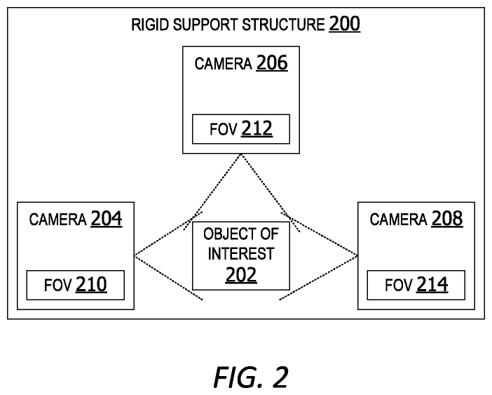

FIG. 2 is an exemplary block diagram illustrating a rigid support structure 200 including a plurality of image capture devices. The rigid support structure 200 is a structure having a frame for mounting one or more image capture devices, such as, but not limited to, the rigid support structure 122 in FIG. 1. The plurality of image capture devices mounted to the rigid support structure 200, in this example, includes a first camera 204, a second camera 206, and a third camera 208.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

In this example, the first camera 204 is mounted to a vertical support member. The first camera 204 has a side view of an object of interest 202. The object of interest can be any type of object. In this example, the object of interest 202 is a shopping cart. In other embodiments, the object of interest 202 can be a checkerboard or any other type of object. The second camera 206 is mounted to a top portion of the rigid support structure which is positioned above the object of interest. In other words, the FOV 210 of the first camera is directed towards a side of the object of interest.

The second camera 206 has a top-down view (bird's-eye-view) of the object of interest 202. The FOV 212 of the second camera is directed downwards towards the floor. The third camera 208 is mounted to a bottom portion of the rigid support structure and has a side view of the object of interest 202. In other words, the FOV 214 of the third camera 208 is directed towards an opposite side of the object of interest than FOV 210 of the first camera.

In this example, the archway truss device includes three cameras. The embodiments are not limited to three cameras. The system can include two cameras, as well as four or more cameras mounted to the rigid support structure 200.

FIG. 3 is an exemplary block diagram illustrating an archway truss device 300 for supporting a plurality of image capture devices generating multi-view image data for a plurality of items. The archway truss device 300 is a support structure for supporting two or more image capture devices 308, such as, but not limited to, the rigid support structure 122 in FIG. 1 and/or the rigid support structure 200 in FIG. 2. The archway truss device 300, in this example, includes a horizontal top member 302. The horizontal top member 302 has a frame 304. The frame 304, in some embodiments, is a metal frame. However, the embodiments are not limited to a metal frame. In other embodiments, the frame 304 is composed of any other appropriate material.

The horizontal top member 302, in some embodiments, includes a mounting bracket 306 or other attachment device for removably attaching an image capture device.

The archway truss device 300 includes a plurality of vertical support members 312. In some embodiments, the plurality of vertical support members 312 includes two vertical support members defining a single lane of travel through the archway truss device 300. In these embodiments, two vertical support members are spaced a predetermined distance apart, which is sufficient to enable at least one user pushing a shopping cart or driving a motorized cart to pass between the two vertical support members of the archway truss device 300 as the user proceeds toward the exit via the lane of travel between the two vertical support members.

In other embodiments, the plurality of vertical support members 312 includes three vertical support members defining two distinct lanes of travel through the archway truss device 300. In still other embodiments, the archway truss device 300 includes four vertical support members defining three lanes of travel through the archway truss device 300. In still other embodiments, the archway truss device 300 includes five or more vertical support members defining four or more lanes of travel through the archway truss device.

Each vertical support member in the plurality of vertical support members 312 includes a frame 314 and optionally includes a covering 316 over the frame. Each vertical support member connects to the horizontal top member 302 at a connection point 318. The connection point 318 is located at a top portion of each vertical support member.

A camera housing 320 is recessed within each vertical support member. The camera housing 320 is sized to encompass an image capture device, such as a camera.

The cameras mounted on the archway truss generate multi-view images of one or more cart(s) 338 optionally containing a plurality of items 340 passing through or near the archway truss device 300. However, the embodiments are not limited to a cart containing a plurality of items. In some embodiments, the cart is empty, or the cart only contains a single item.

The plurality of items includes items such as, but not limited to, the item 342. The item 342 can include any type of item, such as, but not limited to, an item of apparel, comestible, footwear, hardware, tool, pet care product, personal hygiene product, a tool, piece of furniture, a cleaning product, or any other type of item. Each item is identified via an item ID 344, such as, but not limited to, an item UPC. A CV ML model is optionally utilized to determine the item ID of items detected within one or more of the images generated by the image capture devices when the image capture devices are properly installed and correctly calibrated.

Referring now to FIG. 4, an exemplary block diagram illustrating an archway truss device 400 supporting two or more image capture devices is shown. In this example, the archway truss is a single-lane archway truss. The archway truss device 400 is a support structure for supporting a plurality of image capture devices, such as, but not limited to, the rigid support structure 122 in FIG. 1, the rigid support structure 200 in FIG. 2, and/or archway truss device 300 in FIG. 3. In this example, a first vertical support member 402 is attached to a horizontal top member 404. A second vertical support member 406 is attached to the horizontal top member 404. In this example, the first vertical support member 402 and the second vertical support member 406 are spaced apart a pre-defined distance sufficient to enable a single user pushing a cart, carrying a basket, or riding in a motorized cart to pass through the archway between the vertical support members of the archway truss device 400.

In this example, a top camera is attached to a portion 408 of the horizontal top member 404. The portion of the archway truss at which the top camera is mounted can be referred to as a top portion of the support structure. A first bottom camera is attached to a bottom portion 410 of the vertical support member 402. A second bottom camera is attached to a bottom portion 412 of the second vertical support member 406. Each camera captures images having a slightly different view. In this example, the top camera is positioned to capture images of items beneath the camera. The top camera captures images having a top view. The bottom cameras capture images of the sides of items. These images are referred to as having a bottom view or side view.

In this example, only two vertical support members are provided to create a single lane of travel through the archway truss. However, the embodiments are not limited to only two vertical support members. In other embodiments, the archway truss device 400 includes three or more vertical support members, as shown in FIG. 5 below.

FIG. 5 is an exemplary block diagram illustrating a multi-lane archway truss device 500 supporting multiple image capture devices. The multi-lane archway truss device 500 is a support structure for supporting two or more image capture devices 308, such as, but not limited to, the rigid support structure 122 in FIG. 1, the rigid support structure 200 in FIG. 2, and/or the archway truss device 300 in FIG. 3.

In this example, the multi-lane archway truss device 500 includes three vertical support members with a horizontal top member forming two lanes or passageways through the archway. In some embodiments, the multi-lane archway truss device 500 includes one or more recessed camera housings within one or more vertical support members. In this example, an interior side 502 of a first vertical support member 504 includes a recessed camera housing 506. A camera is placed inside the recessed camera housing 506. The camera captures images of a side and/or bottom of a cart, such as a shopping cart, motorized cart, or basket carried by a user moving through a first lane defined by the first vertical support member 504 and the central support member 510.

Likewise, an interior side 508 of the central support member 510 also includes another recessed camera housing 512 for a camera. The camera inside the recessed camera housing 512 captures images of a side and/or bottom of a cart moving through the second lane defined by the central support member 510 and a second vertical support member 514.

In other embodiments, the central support member 510 includes two recessed camera housings. The recessed camera housing 512 is located on a first side of the central support member 510 facing toward the second vertical support member 514, such that the camera in the recessed camera housing can capture images of objects in the second lane. A second recessed camera housing (not shown) is located on an opposite side of the central support member facing toward the first vertical support member 504, such that a camera in the second recessed camera housing can capture images of objects moving through the first lane.

In this example, the archway truss device supports six cameras associated with two exit lanes. The two exit lanes, in this example, are such that when looking towards the interior of a store, the left exit lane can be referred to as exit lane one (Lane 1) and the right exit lane can be referred to as lane two (Lane 2). There are predefined IPs for cameras for each exit lane. For example, lane one includes a camera having an IP number ending in ninety-four (94), the second camera having an IP number ending in ninety-five (95), and the third camera having an IP number ending in ninety-six (96). For exit lane two, a first camera has an IP number ninety-seven (97), a second camera has an IP number ninety-eight (98), and a third camera has an IP number ninety-nine (99). Camera IPs are assigned to cameras, and the assigned IPs for each camera should align correctly with each other. The camera IPs cannot be wrong or intermingled. Each camera should be correctly mounted in terms of height, width, and depth inside the archway truss device. Each camera view should be standard such that it covers the whole cart. An assigned standard view for all cameras is maintained throughout operation. Camera direction is standard across stores, and it is maintained and monitored throughout operation of the cameras.

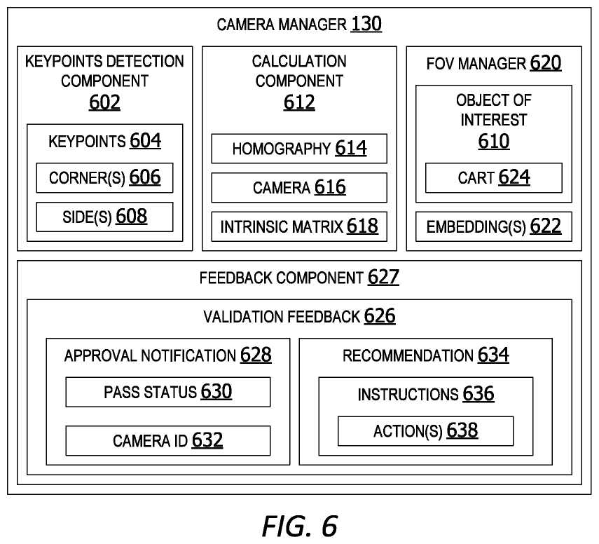

Referring now to FIG. 6, an exemplary block diagram illustrating a camera manager 130 for validating and guiding re-calibration of multiple image capture devices on a rigid support structure is shown. The camera manager 130 obtains multi-view images of a cart or other object of interest from two or more image capture devices mounted to an archway truss device or other rigid support structure. A keypoints detection component 602 detects keypoints 604 within the images of the same object of interest 610. The keypoints 604 can include corner(s) 606 on the rigid support structure, side(s) 608 on one or more of the vertical supports of the rigid support structure, and/or other stationary reference points on the rigid support structure. In this example, the keypoints detection component detects a set of one or more keypoints on a first bottom portion of a first vertical support member and a second bottom portion of a second vertical support member of the archway truss device by a computer vision (CV) machine learning (ML) model.

The camera manager 130, in other embodiments, includes a calculation component 612. The calculation component 612 calculates a homography 614, a camera pose 616, and/or an intrinsic matrix 618 associated with the plurality of multi-view images using the set of keypoints 604 in the images of the object of interest 610. The camera manager determines whether the object of interest, such as a cart 624, appears within a FOV of each image capture device in the plurality of image capture devices using the set of keypoints 604 and the calculated homography 614.

In some embodiments, a FOV manager 620 includes a CV ML model for generating embedding(s) 622 representing the images of the object of interest 610. The FOV manager 620 determines whether the object of interest is within the FOV of each image capture device.

In other embodiments, a feedback component 627 generates a validation feedback 626 indicating whether validation of an image capture device is successful or unsuccessful. If successful, the system generates an approval notification 628. The approval notification 628 includes a pass status 630 for each image capture device and/or a camera ID 632 identifying each image capture device.

The validation feedback 626 optionally includes a recommendation 634 with instructions 636 for correcting an issue or other problem preventing successful validation of a given image capture device. For example, the system can identify problems or issues, such as a camera view that is not level, a camera that is tilted at an incorrect angle, a camera view that is obscured, a camera producing blurry images and/or low-resolution images. The instructions include one or more action(s) 638 for a user to perform to re-calibrate the image capture device failing to receive a pass status.

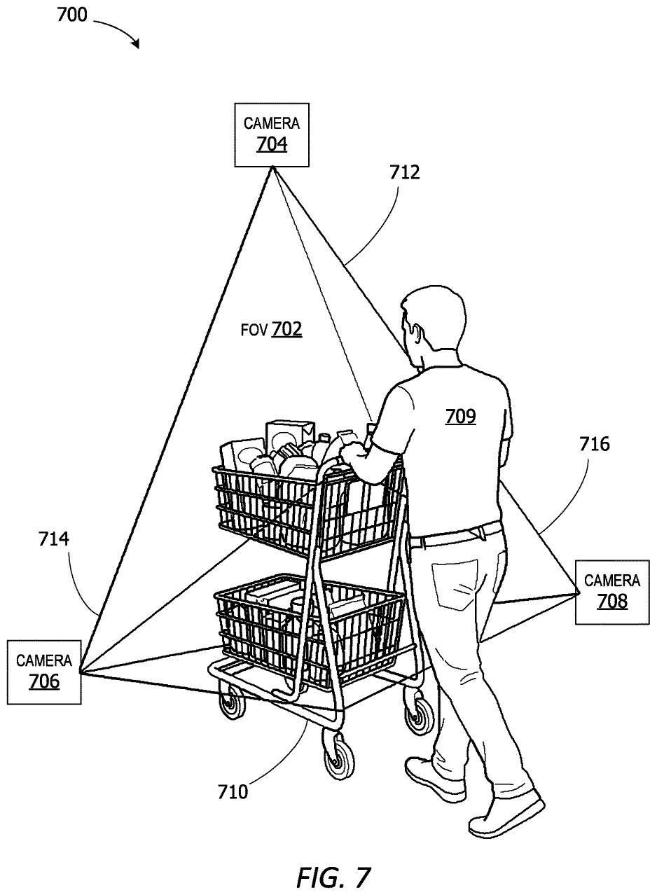

FIG. 7 is an exemplary diagram 700 illustrating a field of view (FOV) 107 of each camera in a plurality of cameras mounted on an archway truss device. In this example, the plurality of cameras includes a first camera 704 mounted to a horizontal top member (not shown) of an archway truss, a second camera 706 mounted to a first vertical side member (not shown) of the archway truss, and a third camera 708 mounted to a second vertical side member (not shown) of the archway truss. The first camera 704 can be referred to as a top camera. The second camera 706 and the third camera 708 can be referred to as bottom cameras.

However, the examples are not limited to three cameras positioned exactly as shown in FIG. 7. In other examples, the plurality of cameras can include a top camera and a single side member camera, two side cameras without the top camera, two or more cameras mounted to the horizontal top member, as well as three or more cameras mounted to the vertical side members. The plurality of cameras can also include one or more cameras mounted to a ceiling, wall, support pillar, or fixture proximate to the archway truss device.

A user 709, in this example, pushes a shopping cart 710 within the FOV of each camera in a set of three cameras mounted above and to the sides of the object of interest. In this example, the shopping cart 710 is the object of interest. The cart is within the combined FOV 702 of the set of cameras. The combined FOV 702 includes the FOV 712 of the first camera 704 above the cart, the FOV 714 of the second camera 706 on the left side of the cart, and the FOV 716 of the third camera 708 at the right side of the cart. The combined FOV 702 encompasses the entirety of the shopping cart 710 in this example. The cameras capture images of carts on the move.

In this example and other examples described herein, the cameras are capturing images of objects of interest, such as shopping carts. Images of users are not to be captured or saved. If an image of a user is inadvertently captured, the user is cropped out of the image and any images or portions of images including users are discarded.

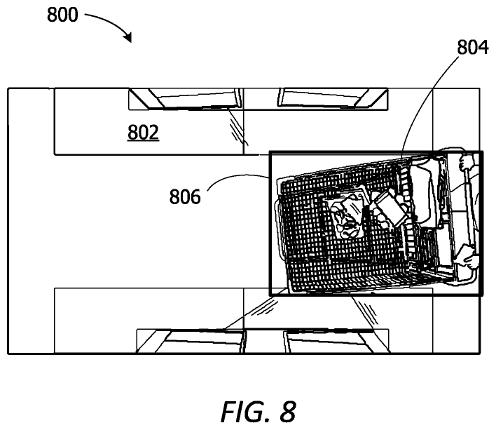

FIG. 8 is an exemplary top view image 800 showing an object of interest within a FOV of a camera mounted to a horizontal top member of an archway truss device 802. The object of interest is a shopping cart 804. The image 800 includes a bounding box 806 enclosing the shopping cart 804. The shopping cart can be referred to as an active cart. The term active cart refers to a cart which is the object of interest. In this example, the active cart is a cart which is actively exiting through the archway truss device 802.

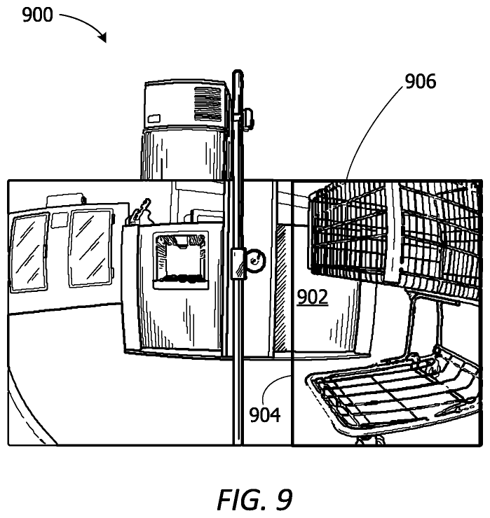

FIG. 9 is an exemplary side view image 900 showing an object of interest within a FOV of a camera mounted to a vertical support member of an archway truss device 902. A bounding box 904 encloses an active cart 906. The active cart in this image 900 is the same cart in the image 800 shown in FIG. 8 above. However, the cart in image 900 is shown in a side view instead of a top view.

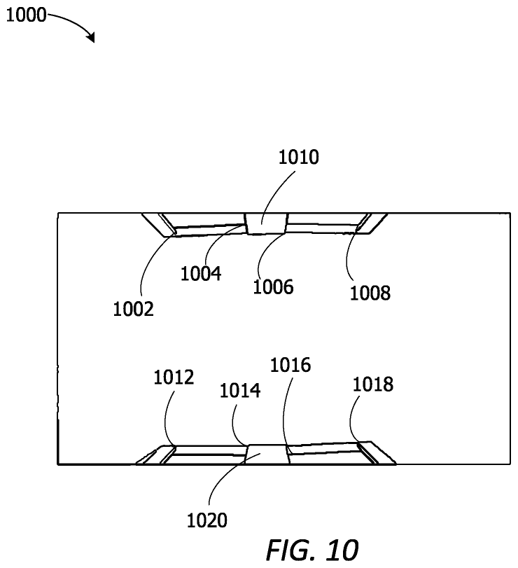

FIG. 10 is an exemplary top view image 1000 including reference regions on an archway truss device for detecting objects of interest. In this example, the reference regions on the archway truss are regions on which one or more keypoints are located. The reference regions on two vertical support members of the archway truss device are visible within the FOV of the top camera. In this example, a first keypoint 1002, a second keypoint 1004, a third keypoint 1006, and a fourth keypoint 1008 are shown on a first vertical support member 1010 of an archway truss device. A fifth keypoint 1012, a sixth keypoint 1014, a seventh keypoint 1016, and an eighth keypoint 1018 are shown on a second vertical support member 1020. The keypoints are used as stationary points of reference or anchor points for comparing objects captured in multi-view images generated by two or more different cameras.

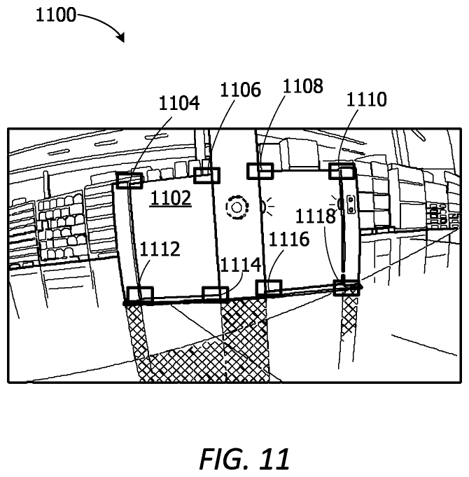

FIG. 11 is an exemplary side view image 1100 including reference regions on an archway truss device 1102. The reference regions on one vertical support member of the archway truss are visible within the FOV of one bottom camera. In this example, the reference regions include keypoint 1104, keypoint 1106, keypoint 1108, keypoint 1110, keypoint 1112, keypoint 1114, keypoint 1116, and keypoint 1118. The keypoints are shown enclosed in bounding boxes within the image 1100.

In some embodiments, for top camera monitoring, the system sets two reference regions for arch pillars/trusses and gets the bounding boxes of the arch pillar/truss. The system uses the distance (in ratio format, d/width) to show a degree to which a top camera is centered. The bottom camera monitoring (pillar/truss) is similar to the top view camera.

In other embodiments, bottom camera monitoring (corners) is performed using a keypoint at each corner. The system gets two sampled square boxes, one is near the corner, and one is far away from the corner. The system calculates the brightness difference between those two square boxes to determine whether this corner is blocked (i.e., dark corner).

In this example, the keypoints include corners on the archway truss as well as a vertical portion (leg) associated with the vertical support member of the archway truss device. The keypoints are detected in images with real-time neural network detection models, such as, but not limited to, a trained CV ML model. Sample training data for training the model(s) is optionally collected with web-based labeling tools.

In some examples, the object of interest can be a checkerboard placed on the ground within the archway truss device. The checkerboard can be used for calculating a homography matrix associated with the cameras mounted on the archway truss device.

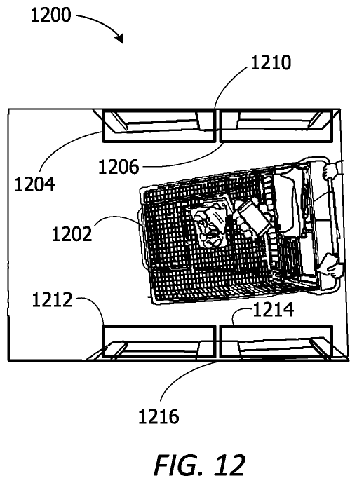

Turning now to FIG. 12, an exemplary top view image 1200 showing reference regions on archway truss device enclosed by bounding boxes with an instruction for re-calibrating the image capture device. In this example, a top view image of an active cart 1202 is shown passing through an archway truss device. A bounding box 1204 is shown enclosing a first reference point of a first vertical support member 1210 of the archway truss device. A second bounding box 1206 is shown enclosing a second reference point on the first vertical support member 1210. A bounding box 1212 is shown enclosing a reference point on the second vertical support member 1216. A bounding box 1214 is shown enclosing a second reference point of the second vertical support member 1216. The reference points are associated with one or more keypoints. In this example, each bounding box enclosing a reference point is associated with two or more keypoints on the archway truss device.

The reference points enclosed within the bounding boxes can be used for calibrating and/or performing testing associated with the top camera mounted to a top horizontal member of the archway truss above the floor. In other examples, a checkerboard on the floor can be used for calibrating the top camera. The checkerboard can be used in place of the active cart for the calibration and testing process.

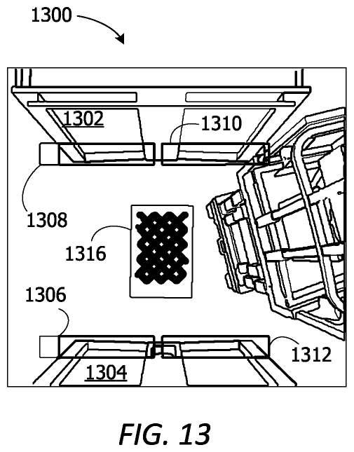

FIG. 13 is an exemplary top view image 1300 showing reference regions on an archway truss device enclosed by bounding boxes with a pass status for the image capture device validation. In this example, a first vertical support member 1302 of an archway truss device and a second vertical support member 1304 of the archway truss device are shown in the top view image 1300. A reference region on the second vertical support member 1304 is enclosed within a bounding box 1306. Another reference region on the second vertical support member 1304 is enclosed in another bounding box 1312.

A reference region enclosed within a bounding box 1308 and a second reference region is shown in a bounding box 1310 of the first vertical support member 1304 are shown. A checkerboard 1316 is shown on the floor within the image 1300. The checkerboard 1316 can be used during homography calculations.

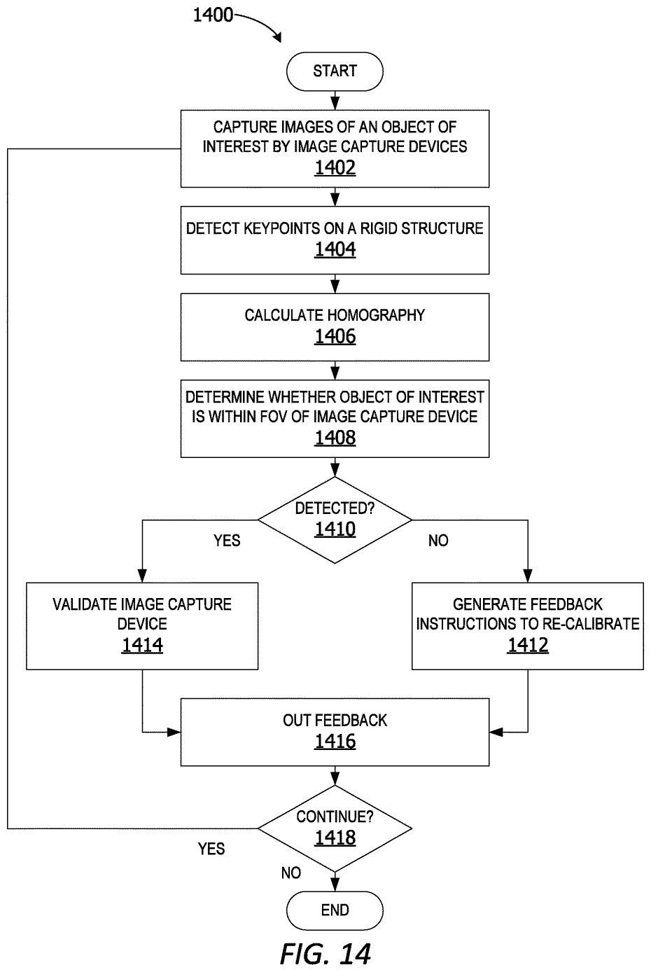

FIG. 14 is an exemplary flow chart illustrating operation of the computing device to validate a plurality of image capture devices mounted to a rigid support structure using a plurality of keypoints. The process 1400 shown in FIG. 14 is performed by a customized returns manager component, executing on a computing device, such as the computing device 102 or the user device 116 in FIG. 1.

The process begins by capturing images of an object of interest by image capture devices at 1402. The image capture devices are devices for generating images from two or more different viewpoints, such as, but not limited to, the image capture device(s) 120 in FIG. 1. The camera manager detects keypoints on a rigid structure at 1404. A homography is calculated at 1406. A determination is made whether an object of interest is within the FOV of an image capture device at 1408. If the object of interest is not detected at 1410, feedback instructions are generated to re-calibrate the image capture device at 1412. If the object of interest is within the FOV, the image capture device is validated at 1414. The feedback is output at 1416. A determination is made whether to continue at 1418. If yes, the process iteratively performs operations 1402 through 1416 until a determination is made not to continue at 1418. The process terminates thereafter.

While the operations illustrated in FIG. 14 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 14.

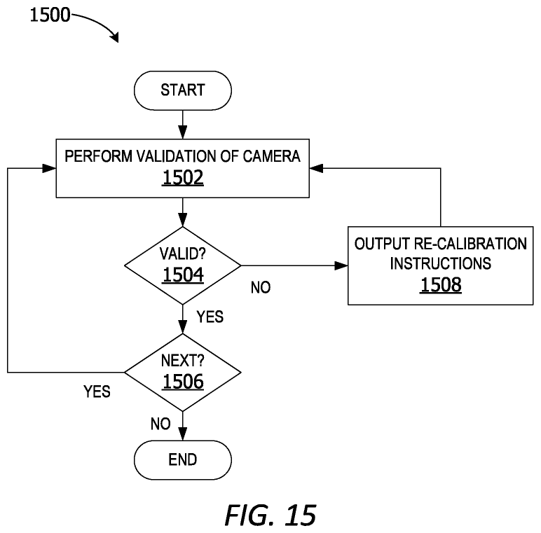

FIG. 15 is an exemplary flow chart illustrating operation of the computing device to validate each camera in a plurality of cameras mounted on a rigid support structure. The process 1500 shown in FIG. 15 is performed by a customized returns manager component, executing on a computing device, such as the computing device 102 or the user device 116 in FIG. 1.

The process begins by performing validation of a camera at 1502. The camera is an image capture device, such as, but not limited to, the one or more image capture devices 120 in FIG. 1. If the camera is not valid at 1504, re-calibration instructions are output at 1508. The instructions are output via a UI, such as, but not limited to, the user interface device 110 and/or the UI 124 in FIG. 1. Validation of the camera is performed again at 1502. If the camera is valid at 1504, a determination is made whether a next camera remains unvalidated at 1506. If yes, the process iteratively executes operations 1502 through 1508 until a next camera is not unvalidated at 1506. The process terminates thereafter.

While the operations illustrated in FIG. 15 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 15.

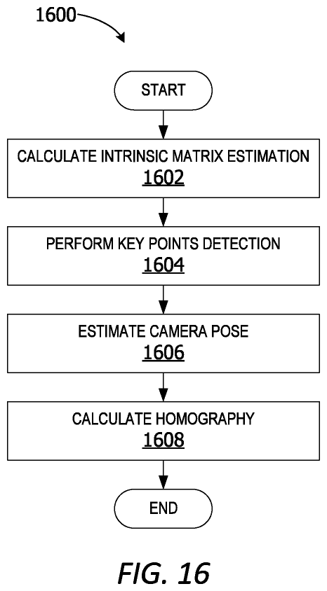

FIG. 16 is an exemplary flow chart illustrating operation of the computing device to calculate a homography estimation for a camera. The process 1600 shown in FIG. 16 is performed by a customized returns manager component, executing on a computing device, such as the computing device 102 or the user device 116 in FIG. 1.

The process begins by calculating an intrinsic matrix estimation at 1602. Keypoints detection is performed at 1604. In some examples, a trained ML model is used to perform the keypoints detection, such as, but not limited to, the one or more ML model(s) 154 in FIG. 1. A camera pose is estimated at 1606. The camera pose refers to the position, orientation, height, depth, angle, or other orientation data associated with the camera. The homography is calculated at 1608 using the camera pose, keypoints, and intrinsic matrix estimation. The process terminates thereafter.

While the operations illustrated in FIG. 16 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 16.

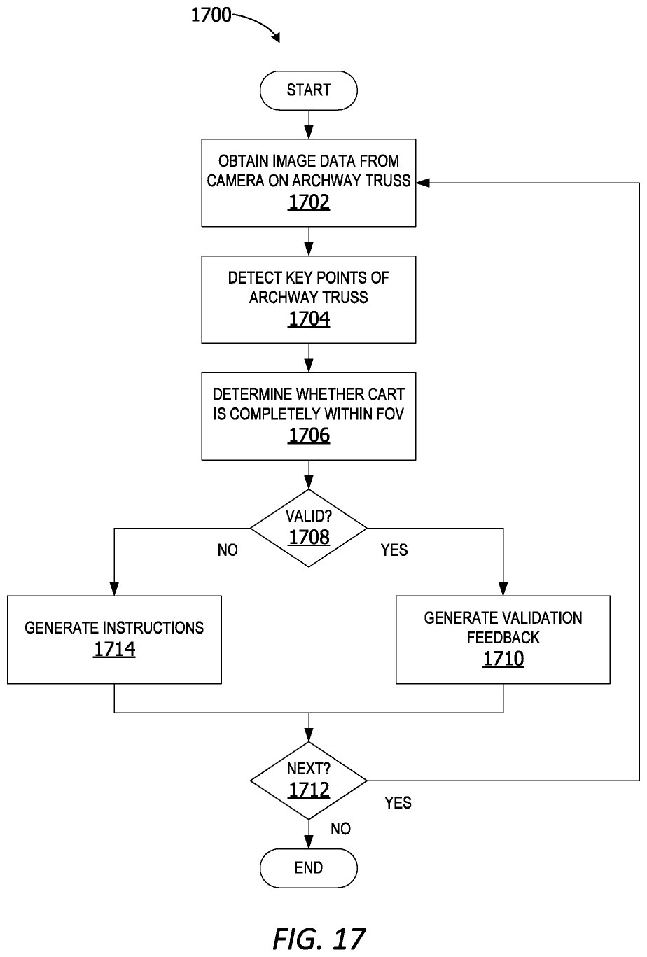

FIG. 17 is an exemplary flow chart illustrating operation of the computing device to generate validation feedback for cameras on an archway truss. The process 1700 shown in FIG. 17 is performed by a customized returns manager component, executing on a computing device, such as the computing device 102 or the user device 116 in FIG. 1.

The process begins by obtaining image data from a camera mounted on an archway truss at 1702. The archway truss is a rigid support structure, such as, but not limited to, the rigid support structure 122 in FIG. 1, the rigid support structure 200 in FIG. 2, the archway truss device 300 in FIG. 3, the archway truss device 400 in FIG. 4, and/or the multi-lane archway truss device 500 in FIG. 5. Keypoints on an archway are detected in the image data at 1704. A determination is made whether the cart is completely within the FOV of the camera at 1706. A determination is made whether the camera is valid at 1708. If not, instructions are generated at 1714. The instructions are instructions to guide a user in re-calibrating the camera, such as, but not limited to, the instructions 134 in FIG. 1. A determination is made whether a next camera 1712 is ready to be validated. The next camera can be a new camera or the previous camera which failed validation at 1708. If a camera is validated at 1708, the system generates validation feedback at 1710. The validation feedback is output via a UI and includes a pass status or other notification indicating the validation was successful. If a next camera remains unvalidated at 1712, the process iteratively executes operations 1702 through 1712 until a next camera does not remain for validation at 1712. The process terminates thereafter.

While the operations illustrated in FIG. 17 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 17.

The order of execution or performance of the operations in FIG. 14, FIG. 15, FIG. 16, and FIG. 17, as well as in other examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

FIG. 18 is an exemplary diagram illustrating a user interface 1800 including validation feedback for a camera. In this example, clicking on the ‘Next’ button updates the UI to the camera FOV (Field of View) adjustment position check screen. The system then prompts the user to adjust one or more cameras such that a current bounding box comes closer to a target bounding box. The system provides recommendations (suggestions) through one or more prompts on the display. After each adjustment to the camera, the user clicks on a ‘Check Camera’ button and then ‘Load Results’ button to see if they are good to go to validation of the next camera. If ‘Good to Go Next’ prompt is displayed, the user can click on ‘Next’ button and ‘Load Results’ to view validation results for the next camera of the exit lane.

In some embodiments, the system provides suggestions for adjusting a bottom camera, such as, an instruction to move the camera up, move the camera down, or rotate the camera. Based on the detection of opposite truss left bounding boxes, it is configured to ensure the final view includes the entire bottom cart and a significant portion of the side cart. The user continues selecting “next” to perform validation of FOV for all six cameras (3 cameras from Lane 1 and 3 cameras from Lane 2).

FIG. 19 is an exemplary table 1900 illustrating validation results for a set of three cameras. The table 1900 includes a camera name 1902, an IP number 1904 associated with each camera, a parameter check result 1906, and a cart detection result 1908. The validation results, in this example, indicate a pass status for every camera identified in the table 1900. During validation of the parameters for one or more of the cameras, the system checks parameters such as, but not limited to, magnification, rotation angle, shutter speed, lock aperture, exposure level, focus, etc.

### ADDITIONAL EXAMPLES

In some examples, the system provides a web-tool to automate a camera installation and validation process for multiple cameras on a rigid support structure. The tool starts with asking a user (installer) to place an object of interest, such as a cart, under one of the lane archway truss devices and then it checks all camera IPs, their parameters, and detects the cart and its direction placed under the selected lane. If all cameras of the selected lane are able to detect the cart and direction of the cart in images from each camera, the tool also validates that all of their parameters and IPs are correctly set. It provides a pass status or instructions for a user to adjust the parameter(s) of the camera or adjust the IP or cart placement adjustments for any camera failing to be validated.

For example, if a cart is placed under lane two, ideally all cameras should include the cart in each camera's FOV. If only two of the cameras include the cart in their FOV but one camera does not, the system determines the reason. For example, if a camera ninety-seven (97) and ninety-eight (98) but a camera ninety-nine (99) on the same Lane A does not have the cart in the FOV, while the FOV of a camera ninety-six (96) assigned to another Lane B does include the object of interest, the system switches the assignment of cameras ninety-nine and ninety-six. In other words, the system is able to re-assign camera ninety-nine to Lane B and re-assign camera ninety-six to Lane A. Alternatively, instead of automatically correcting the assignment of the cameras, the system outputs instructions recommending the user switch the camera assignments.

The system, in other embodiments, introduces an automated homography estimation based on keypoints on a rigid structure. The solution consists of a camera intrinsic matrix estimation. The camera intrinsic matrix can be estimated in the traditional way with a checkerboard, as the camera adopted is the same across the chain. Key point autodetection is performed using one or more keypoints of a rigid structure. A keypoint is detected with neural networks trained with labeled data with our web-based labeling tools. Camera pose estimation is used to estimate a camera pose based on the intrinsic matrix and key points of the rigid structure and the structure size, i.e., the three-dimensional (3D) coordinates of the keypoints. A final homography can be estimated based on the intrinsic matrix estimation, camera pose estimation, and the rigid structure size. In some embodiments, the final homography estimation is calculated as follows:

$$\vert [ \begin{matrix}{X}_{1} \\ {Y}_{1} \\ {Z}_{1}\end{matrix} ] = \vert = ( {R}_{1} {R}_{2}^{T} - ( - {R}_{1} {R}_{2}^{T} {t}_{2} + {t}_{1} ) \frac{{n}^{T}}{d} ) [ \begin{matrix}{X}_{2} \\ {Y}_{2} \\ {Z}_{2}\end{matrix} ] \\ \frac{{s}_{1}}{{s}_{2}} [ \begin{matrix}{u}_{1} \\ {v}_{1} \\ 1\end{matrix} ] = {K}_{1} {HK}_{2}^{- 1} [ \begin{matrix}{u}_{2} \\ {v}_{2} \\ 1\end{matrix} ]$$

where K is the intrinsic matrix and R,t is camera pose (rotation and translation matrix).

In some embodiments, the system provides a unique automated standard camera installation and validation that incorporates focused trained models for detecting a cart, truss legs, truss corners/portions to provide the ground truth target FOV for each camera. The system provides automated prompts based on the camera view. It is easy to scale and use, to save hundreds or thousands of hours of manual work for camera installers and maintenance personnel. The system enables automated easy monitoring of the quality of installed and calibrated cameras at scale.

Some embodiments provide a system that automates multi-camera installation and multi-camera validation process using a web-tool. The system generates prompts on the display to adjust the cameras. The system includes a cart that is placed under a set of cameras in an exit lane. The system checks all camera internet protocols (IP), their parameters, and detects the cart and the cart's direction placed under the selected lane. The system provides a pass status if all cameras (a set of 3 cameras) mounted to the archway truss of the selected lane are able to see the cart and the direction of the cart from each camera, and all their parameters and IPs are correctly set. In case of failure, the tool provides suggestions through the prompt on a display for camera adjustments. The method uses reference regions for arch pillars/trusses (i.e., red bounding boxes) and gets the bounding boxes of the arch pillar/truss (i.e., green bounding boxes). The system uses the distance (in ratio format, d/width) to show the centeredness of the top camera. The system uses focused trained models for detecting the cart, truss legs, truss corners/portions to provide the ground truth target field of view (FOV).

Other embodiments provide a system for automated homography estimation based on keypoints on a rigid structure (support structure/archway support). The system calibrates multiple cameras mounted on an archway truss to capture images of an object of interest (shopping cart). The system estimates a camera intrinsic matrix (in the traditional way) with a checkerboard. The system detects the key points of the rigid structure using a machine learning model/neural network model trained with labeled data (via the web-based labeling tools). The system estimates the camera pose based on the intrinsic matrix and key points of the rigid structure and the structure size (i.e., the 3D coordinates of the keypoints). The system calculates the final homography using the estimated intrinsic matrix, camera pose, and the detected rigid structure/archway truss size.

The system eliminates the need for manually created texture patterns on a surface that need homography estimation by leveraging the keypoints of the available rigid structure. The system calculates the homography based on camera poses instead of direct keypoints regression across different views. The system automates the process and avoids continuous and immediate human labeling effort when the camera pose changes by using a neural network to detect keypoints of the rigid structure. The estimated homography achieves greater than 99.6% precision for cart association across different camera views.

Alternatively, or in addition to the other examples described herein, examples include any combination of the following:
wherein the set of keypoints comprises a set of corners associated with the first bottom portion of the first vertical support member, or a set of corners associated with the second bottom portion of the second vertical support member;
validate a first camera in the plurality of image capture devices mounted to a horizontal top member of the archway truss device;
responsive to successful validation of the first camera, validate a second camera in the plurality of image capture devices mounted to the first bottom portion of the first vertical support member;
responsive to successful validation of the second camera, validate a third camera in the plurality of image capture devices mounted to the second bottom portion of the second vertical support member;
check a set of parameters associated with a first camera in the plurality of image capture devices;
responsive to a failure to detect substantially all of the cart within the FOV of the first camera, generate a recommendation for re-calibrating the first camera;
responsive to receiving a request to check the first camera, determine whether the cart appears within the FOV of the first camera using the set of keypoints detected within an image generated by the first camera;
verify a set of camera internet protocol (IP) numbers assigned to each camera in the plurality of image capture devices;
responsive to verification of the set of camera IP numbers, generate feedback including an IP verification notification;
responsive to failure to verify the set of camera IP numbers, generate a prompt requesting a corrective action associated with the set of camera IP numbers;
provide a pass status for the plurality of image capture devices responsive to a determination that an IP address of each image capture device is correct, the cart appears within the FOV of each image capture device, and a set of parameters for each camera is verified;
wherein the plurality of multi-view images comprises a first set of images generated at a first time period;
obtain a second set of images generated at a second time period, wherein the second time period is a later time period than the first time period;
analyze the second set of images to determine whether an object of interest appears within the FOV of every image capture device in the plurality of image capture devices;
responsive to a failure to detect the object of interest within the FOV of at least one image capture device in the plurality of image capture devices, generate an alert in real-time indicating that maintenance of the at least one image capture device is recommended;
calculate an intrinsic matrix estimation using the plurality of multi-view images;
perform keypoint detection by the CV ML model trained using labeled training data to detect each keypoint on the archway truss device within the set of keypoints;
estimate camera pose for each image capture device based on an intrinsic matrix estimation and the set of keypoints;
calculate the homography matrix based on the intrinsic matrix estimation, the estimated camera pose, and the set of keypoints;
detecting, within a plurality of multi-view images generated by a plurality of image capture devices mounted to an archway truss device, a set of keypoints on a first bottom portion of a first vertical support member and a second bottom portion of a second vertical support member of the archway truss device by a computer vision (CV) machine learning (ML) model;
calculating a homography matrix associated with the plurality of multi-view images using the set of keypoints;
determining whether a cart appears within a field of view (FOV) of each image capture device in the plurality of image capture devices using the set of keypoints and the calculated homography matrix;
generating validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device;
checking a set of parameters associated with a first camera in the plurality of image capture devices;
responsive to a failure to detect substantially all of the cart within the FOV of the first camera, generating the recommendation for re-calibrating the first camera;
responsive to receiving a request to check the first camera, re-checking the set of parameters, wherein the first camera is validated responsive to detecting substantially all of the cart within the FOV of the first camera;
verifying a set of camera internet protocol (IP) numbers assigned to each camera in the plurality of image capture devices;
responsive to verification of the set of camera IP numbers, generating feedback including an IP verification notification;
responsive to failure to verify the set of camera IP numbers, generating a prompt requesting a corrective action associated with the set of camera IP numbers;
providing a pass status for the plurality of image capture devices responsive to a determination that an IP address of each image capture device is correct, the cart appears within the FOV of each image capture device, and a set of pre-defined parameters for each camera is verified;
obtaining a second set of images generated at a second time period, wherein the second time period is a later time period than the first time period;
analyzing the second set of images to determine whether an object of interest appears within the FOV of every image capture device in the plurality of image capture devices;
responsive to a failure to detect the object of interest within the FOV of at least one image capture device in the plurality of image capture devices, generating an alert in real-time indicating that maintenance of the at least one image capture device is recommended;
calculating an intrinsic matrix estimation using the plurality of multi-view images;
performing keypoint detection by the CV ML model trained using labeled training data to detect each keypoint on the archway truss device within the set of keypoints;
estimating camera pose for each image capture device based on an intrinsic matrix estimation and the set of keypoints; and
calculating the homography matrix based on the intrinsic matrix estimation, the estimated camera pose, and the set of keypoints.

At least a portion of the functionality of the various elements in FIG. 1, FIG. 2, FIG. 3, FIG. 4, FIG. 5, FIG. 6, and/or FIG. 7 can be performed by other elements in FIG. 1, FIG. 2, FIG. 3, FIG. 4, FIG. 5, FIG. 6, and/or FIG. 7, or an entity (e.g., processor 106, web service, server, application program, computing device, etc.) not shown in FIG. 1, FIG. 2, FIG. 3, FIG. 4, FIG. 5, FIG. 6, and/or FIG. 7.

In some examples, the operations illustrated in FIG. 18, FIG. 19, FIG. 20, and FIG. 21 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer-readable medium having instructions recorded thereon, which when executed by a computer device, cause the computer device to cooperate in performing a method of validating and guided re-calibration of multiple cameras on an archway truss, the method comprising detecting, within a plurality of multi-view images generated by a plurality of image capture devices mounted to an archway truss device, a set of keypoints on a first bottom portion of a first vertical support member and a second bottom portion of a second vertical support member of the archway truss device by a computer vision (CV) machine learning (ML) model; calculating a homography matrix associated with the plurality of multi-view images using the set of keypoints; determining whether a cart appears within a field of view (FOV) of each image capture device in the plurality of image capture devices using the set of keypoints and the calculated homography matrix; and generating validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device.

While the aspects of the disclosure have been described in terms of various examples with their associated operations, a person skilled in the art would appreciate that a combination of operations from any number of different examples is also within the scope of the aspects of the disclosure.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules, and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special-purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set-top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein, as well as examples not specifically described herein but within the scope of aspects of the disclosure, constitute exemplary means for validation of cameras using keypoints on a rigid support structure. For example, the elements illustrated in FIG. 1, FIG. 2, FIG. 3, FIG. 4, FIG. 5, FIG. 6, and FIG. 7, such as when encoded to perform the operations illustrated in FIG. 18, FIG. 19, FIG. 20, and FIG. 21, constitute exemplary means for detecting, within a plurality of multi-view images generated by a plurality of image capture devices mounted to an archway truss device, a set of keypoints on a first bottom portion of a first vertical support member and a second bottom portion of a second vertical support member of the archway truss device by a computer vision (CV) machine learning (ML) model; exemplary means for calculating a homography matrix associated with the plurality of multi-view images using the set of keypoints; exemplary means for determining whether a cart appears within a field of view (FOV) of each image capture device in the plurality of image capture devices using the set of keypoints and the calculated homography matrix; and exemplary means for generating validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device.

Other non-limiting examples provide one or more computer storage devices having computer-executable instructions stored thereon for providing automated validation and guided re-calibration of cameras on a rigid support structure. When executed by a computer, the computer performs operations including detecting, within a plurality of multi-view images generated by a plurality of image capture devices mounted to an archway truss device, a set of keypoints on a first bottom portion of a first vertical support member and a second bottom portion of a second vertical support member of the archway truss device by a computer vision (CV) machine learning (ML) model; calculating a homography matrix associated with the plurality of multi-view images using the set of keypoints; determining whether a cart appears within a field of view (FOV) of each image capture device in the plurality of image capture devices using the set of keypoints and the calculated homography matrix; and generating validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for multi-camera validation and re-calibration guidance, the system comprising:
a processor; and
a computer-readable medium storing instructions that are operative upon execution by the processor to:
capture a plurality of multi-view images of a cart by a plurality of image capture devices mounted to an archway truss device;
detect, within the plurality of multi-view images, a set of keypoints on a first bottom portion of a first vertical support member and a second bottom portion of a second vertical support member of the archway truss device by a computer vision (CV) machine learning (ML) model;
calculate a homography matrix associated with the plurality of multi-view images using the set of keypoints;
determine whether the cart appears within a field of view (FOV) of each image capture device in the plurality of image capture devices using the set of keypoints and the calculated homography matrix; and
generate validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device.

2. The system of claim 1, wherein the set of keypoints comprises a set of corners associated with the first bottom portion of the first vertical support member, or a set of corners associated with the second bottom portion of the second vertical support member, wherein the instructions are further operative to:
validate a first camera in the plurality of image capture devices mounted to a horizontal top member of the archway truss device;
responsive to successful validation of the first camera, validate a second camera in the plurality of image capture devices mounted to the first bottom portion of the first vertical support member; and
responsive to successful validation of the second camera, validate a third camera in the plurality of image capture devices mounted to the second bottom portion of the second vertical support member.

3. The system of claim 1, wherein the instructions are further operative to:
check a set of parameters associated with a first camera in the plurality of image capture devices;
responsive to a failure to detect substantially all of the cart within the FOV of the first camera, generate the recommendation for re-calibrating the first camera; and
responsive to receiving a request to check the first camera, determine whether the cart appears within the FOV of the first camera using the set of keypoints detected within an image generated by the first camera.

4. The system of claim 1, wherein the instructions are further operative to:
verify a set of camera internet protocol (IP) numbers assigned to each camera in the plurality of image capture devices;
responsive to verification of the set of camera IP numbers, generate feedback including an IP verification notification; and
responsive to failure to verify the set of camera IP numbers, generate a prompt requesting a corrective action associated with the set of camera IP numbers.

5. The system of claim 1, wherein the instructions are further operative to:
provide a pass status for the plurality of image capture devices responsive to a determination that an IP address of each image capture device is correct, the cart appears within the FOV of each image capture device, and a set of parameters for each camera is verified.

6. The system of claim 1, wherein the plurality of multi-view images comprises a first set of images generated at a first time period, and wherein the instructions are further operative to:
obtain a second set of images generated at a second time period, wherein the second time period is a later time period than the first time period;
analyze the second set of images to determine whether an object of interest appears within the FOV of every image capture device in the plurality of image capture devices; and
responsive to a failure to detect the object of interest within the FOV of at least one image capture device in the plurality of image capture devices, generate an alert in real-time indicating that maintenance of the at least one image capture device is recommended.

7. The system of claim 1, wherein the instructions are further operative to:
calculate an intrinsic matrix estimation using the plurality of multi-view images;
perform keypoint detection by the CV ML model trained using labeled training data to detect each keypoint on the archway truss device within the set of keypoints;
estimate camera pose for each image capture device based on an intrinsic matrix estimation and the set of keypoints; and
calculate the homography matrix based on the intrinsic matrix estimation, the estimated camera pose, and the set of keypoints.

8. A method for multi-camera validation and re-calibration guidance, the method comprising:
detecting, within a plurality of multi-view images generated by a plurality of image capture devices mounted to an archway truss device, a set of keypoints on a first bottom portion of a first vertical support member and a second bottom portion of a second vertical support member of the archway truss device by a computer vision (CV) machine learning (ML) model;
calculating a homography matrix associated with the plurality of multi-view images using the set of keypoints;
determining whether a cart appears within a field of view (FOV) of each image capture device in the plurality of image capture devices using the set of keypoints and the calculated homography matrix; and
generating validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device.

9. The method of claim 8, wherein the set of keypoints comprises a set of corners.

10. The method of claim 8, further comprising:
checking a set of parameters associated with a first camera in the plurality of image capture devices;
responsive to a failure to detect substantially all of the cart within the FOV of the first camera, generating the recommendation for re-calibrating the first camera; and
responsive to receiving a request to check the first camera, re-checking the set of parameters, wherein the first camera is validated responsive to detecting substantially all of the cart within the FOV of the first camera.

11. The method of claim 8, further comprising:
verifying a set of camera internet protocol (IP) numbers assigned to each camera in the plurality of image capture devices;
responsive to verification of the set of camera IP numbers, generating feedback including an IP verification notification; and
responsive to failure to verify the set of camera IP numbers, generating a prompt requesting a corrective action associated with the set of camera IP numbers.

12. The method of claim 8, further comprising:
providing a pass status for the plurality of image capture devices responsive to a determination that an IP address of each image capture device is correct, the cart appears within the FOV of each image capture device, and a set of pre-defined parameters for each camera is verified.

13. The method of claim 8, wherein the plurality of multi-view images comprising a first set of images generated at a first time period, and further comprising:
obtaining a second set of images generated at a second time period, wherein the second time period is a later time period than the first time period;
analyzing the second set of images to determine whether an object of interest appears within the FOV of every image capture device in the plurality of image capture devices; and
responsive to a failure to detect the object of interest within the FOV of at least one image capture device in the plurality of image capture devices, generating an alert in real-time indicating that maintenance of the at least one image capture device is recommended.

14. The method of claim 8, further comprising:
calculating an intrinsic matrix estimation using the plurality of multi-view images;
performing keypoint detection by the CV ML model trained using labeled training data to detect each keypoint on the archway truss device within the set of keypoints;
estimating camera pose for each image capture device based on an intrinsic matrix estimation and the set of keypoints; and
calculating the homography matrix based on the intrinsic matrix estimation, the estimated camera pose, and the set of keypoints.

15. One or more computer storage devices having computer-executable instructions stored thereon, which, upon execution by a computer, cause the computer to perform operations comprising:
detecting, within a plurality of multi-view images generated by a plurality of image capture devices mounted to an archway truss device, a set of keypoints on a first bottom portion of a first vertical support member and a second bottom portion of a second vertical support member of the archway truss device by a computer vision (CV) machine learning (ML) model;
calculating a homography matrix associated with the plurality of multi-view images using the set of keypoints;
determining whether a cart appears within a field of view (FOV) of each image capture device in the plurality of image capture devices using the set of keypoints and the calculated homography matrix; and
generating validation feedback associated with the plurality of image capture devices, the validation feedback comprising an approval of each image capture device having a FOV including substantially all of the cart or a recommendation including instructions for re-calibrating an image capture device in the plurality of image capture devices having a FOV that fails to include substantially all of the cart within the FOV, wherein the validation feedback is presented to a user via a user interface device.

16. The one or more computer storage devices of claim 15, wherein the operations further comprise:
validating a first camera in the plurality of image capture devices mounted to a horizontal top member of the archway truss device;
responsive to successful validation of the first camera, validating a second camera in the plurality of image capture devices mounted to the first bottom portion of the first vertical support member; and
responsive to successful validation of the second camera, validating a third camera in the plurality of image capture devices mounted to the second bottom portion of the second vertical support member.

17. The one or more computer storage devices of claim 15, wherein the operations further comprise:
verifying a set of camera internet protocol (IP) numbers assigned to each camera in the plurality of image capture devices;
responsive to verification of the set of camera IP numbers, generating feedback including an IP verification notification; and
responsive to failure to verify the set of camera IP numbers, generating a prompt requesting a corrective action associated with the set of camera IP numbers.

18. The one or more computer storage devices of claim 15, wherein the operations further comprise:
providing a pass status for the plurality of image capture devices responsive to a determination that an IP address of each image capture device is correct, the cart appears within the FOV of each image capture device, and a set of pre-defined parameters for each camera is verified.

19. The one or more computer storage devices of claim 15, wherein the plurality of multi-view images comprises a first set of images generated at a first time period, and wherein the operations further comprise:
obtaining a second set of images generated at a second time period, wherein the second time period is a later time period than the first time period;
analyzing the second set of images to determine whether an object of interest appears within the FOV of every image capture device in the plurality of image capture devices; and
responsive to a failure to detect the object of interest within the FOV of at least one image capture device in the plurality of image capture devices, generating an alert in real-time indicating that maintenance of the at least one image capture device is recommended.

20. The one or more computer storage devices of claim 15, wherein the operations further comprise:
calculating an intrinsic matrix estimation using the plurality of multi-view images;
performing keypoint detection by the CV ML model trained using labeled training data to detect each keypoint on the archway truss device within the set of keypoints;
estimating camera pose for each image capture device based on an intrinsic matrix estimation and the set of keypoints; and
calculating the homography matrix based on the intrinsic matrix estimation, the estimated camera pose, and the set of keypoints.
